(19) United States
(12) Patent Application Publication
(10) Pub. No.: US 2026/0302556 A1
(43) Pub. Date: Oct. 1, 2026

(54) Secondary Battery and Electrode Lead Joining Method

(71) Applicant: LG Energy Solution, Ltd., Seoul (KR)

(72) Inventors: Eui Jin Hong, Daejeon (KR); Jae Won Moon, Daejeon (KR); Min Soo Park, Daejeon (KR)

(73) Assignee: LG Energy Solution, Ltd., Seoul (KR)

(21) Appl. No.: 19/572,324

(22) Filed: Mar. 19, 2026

(30) Foreign Application Priority Data
Apr. 1, 2025 (KR) 10-2025-0042446
Mar. 5, 2026 (KR) 10-2026-0040038

(51) Int. Cl. H01M 50/536; H01M 4/66; H01M 50/528; H01M 50/533; H01M 50/534; H01M 50/54

(52) U.S. Cl. CPC H01M 50/536; H01M 4/667; H01M 50/528; H01M 50/533; H01M 50/534; H01M 50/54; H01M 2220/20

(57) ABSTRACT

An electrode lead joining method includes: stacking a welding metal plate and a tab of a secondary battery; welding the welding metal plate and the tab that have been stacked, thereby forming a welded intermediate body; stacking the welded intermediate body and a metal lead; welding the welded intermediate body and the metal lead that have been stacked.

### CROSS REFERENCES TO RELATED APPLICATIONS

This application is based on and claims priority from Korean Patent Application No. 10-2025-0042446, filed on Apr. 1, 2025 and Korean Patent Application No. 10-2026-0040038, filed on Mar. 5, 2026, with the Korean Intellectual Property Office, the disclosure of which is incorporated herein in its entirety by reference.

### TECHNICAL FIELD

The present disclosure relates to a secondary battery and a method of joining an electrode lead of the secondary battery.

### BACKGROUND

Unlike primary batteries that are not rechargeable, secondary batteries can be recharged repeatedly, and are widely used in electronic devices such as mobile phones, laptops, and camcorders, or in electric vehicles.

Types of secondary batteries include nickel-cadmium batteries, nickel-metal hydride batteries, lithium-ion batteries, and lithium-ion polymer batteries. Such secondary batteries are applied not only to small-sized products such as digital cameras, P-DVDs, MP3 players, mobile phones, PDAs, portable game devices, power tools, and E-bikes, but also to large-sized products requiring high output such as electric vehicles and hybrid vehicles, and furthermore, to energy storage systems and backup power storage systems for storing surplus generated power or renewable energy.

In order to manufacture secondary batteries, first, an electrode active material slurry is applied to a positive electrode current collector and a negative electrode current collector to form a positive electrode and a negative electrode, respectively, and a separator is interposed between the positive electrode and the negative electrode, thereby forming an electrode assembly having a predetermined shape. Then, the electrode assembly is accommodated in a battery case, an electrolyte is injected thereinto, and then, the battery is sealed.

According to the shape of the battery case, secondary batteries may be classified into cylindrical or prismatic batteries in which the electrode assembly is accommodated in a cylindrical or prismatic metal can, and pouch-type batteries in which the electrode assembly is accommodated in a pouch-type case made of a laminate sheet.

Meanwhile, in manufacturing the secondary batteries, electrode tabs and a metal lead are welded to each other using, for example, ultrasonic welding, laser welding, or resistance welding. Here, joining the electrode tabs and the metal lead to each other by the welding methods without damaging the materials is an important factor for maintaining appropriate joining strength and contact resistance.

### SUMMARY

Embodiments of the present disclosure provide an electrode lead joining method, which may resolve problems that occur during the process of welding the metal lead and the tab of a secondary battery, and a secondary battery including the electrode lead formed by the method.

According to an embodiment of the present disclosure, an electrode lead joining method may include: stacking a welding metal plate and a tab of a secondary battery; welding the welding metal plate and the tab that have been stacked, thereby forming a welded intermediate body; stacking the welded intermediate body and a metal lead; welding the welded intermediate body and the metal lead that have been stacked.

According to another embodiment of the present disclosure, a secondary battery may include: an electrode assembly; a tab extending from the electrode assembly; a first welding metal plate coupled to the tab; and a metal lead coupled to the first welding metal plate.

According to an embodiment of the present disclosure, the tab of a secondary battery that is made up with a composite current collector may be welded to a metal lead by a laser welding while maintaining an appropriate strength and minimizing damage to the tab, and a secondary battery including the tab having an appropriate joining strength may be produced.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a view schematically illustrating the internal structure of a pouch-type secondary battery.

FIG. 2 is a flowchart illustrating an electrode lead joining method according to a first embodiment of the present disclosure.

FIG. 3 is a sectional view illustrating the layered structure of a composite current collector that makes up a tab of a secondary battery according to the first embodiment of the present disclosure.

FIG. 4 is a view illustrating a step of stacking the tab of the secondary battery and a welding metal plate in the electrode lead joining method according to the first embodiment of the present disclosure.

FIG. 5 is a view illustrating a first welding step of welding the welding metal plate and the tab in the electrode lead joining method according to the first embodiment of the present disclosure.

FIG. 6 is a view illustrating a welded intermediate body formed in the electrode lead joining method according to the first embodiment of the present disclosure.

FIG. 7 is a conceptual view illustrating the cross section of the welded intermediate body according to the first embodiment of the present disclosure.

FIG. 8 is a view illustrating a second welding step of the electrode lead joining method according to the first embodiment of the present disclosure.

FIG. 9 is a view illustrating a state where the tab and the metal lead are joined to each other by the electrode lead joining method according to the first embodiment of the present disclosure.

FIG. 10 is a conceptual view illustrating the cross section of the electrode lead according to the first embodiment of the present disclosure.

FIG. 11 is a block diagram illustrating the hardware configuration for implementing a control unit included in an electrode lead joining apparatus according to the present disclosure.

FIG. 12 is a view illustrating a second welding step of an electrode lead joining method according to a second embodiment of the present disclosure.

FIG. 13 is a view illustrating the electrode lead according to the second embodiment of the present disclosure, in which the lower side thereof is exposed.

FIG. 14 is a conceptual view illustrating the cross section of the electrode lead according to the second embodiment of the present disclosure.

FIG. 15 is a view illustrating a first welding step of an electrode lead joining method according to a third embodiment of the present disclosure.

FIG. 16 is a view illustrating a welded intermediate body according to the third embodiment, in which the upper side thereof is exposed.

FIG. 17 is a view illustrating the welded intermediate body according to the third embodiment of the present disclosure, in which the lower side thereof is exposed.

FIG. 18 is a conceptual view illustrating the cross section of the welded intermediate body according to the third embodiment of the present disclosure.

FIG. 19 is a view illustrating a second welding step of the electrode lead joining method according to the third embodiment of the present disclosure.

FIG. 20 is a view illustrating the electrode lead according to the third embodiment, in which the upper side thereof is exposed.

FIG. 21 is a conceptual view illustrating the cross section of the electrode lead according to the third embodiment of the present disclosure.

FIG. 22 is a view illustrating an electrode lead according to a fourth embodiment of the present disclosure, in which the upper side thereof is exposed.

FIG. 23 is a conceptual view illustrating the cross section of the electrode lead according to the fourth embodiment of the present disclosure.

FIG. 24 is a schematic perspective view illustrating a vehicle including a secondary battery that includes a metal lead manufactured by the method according to an embodiment of the present disclosure.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

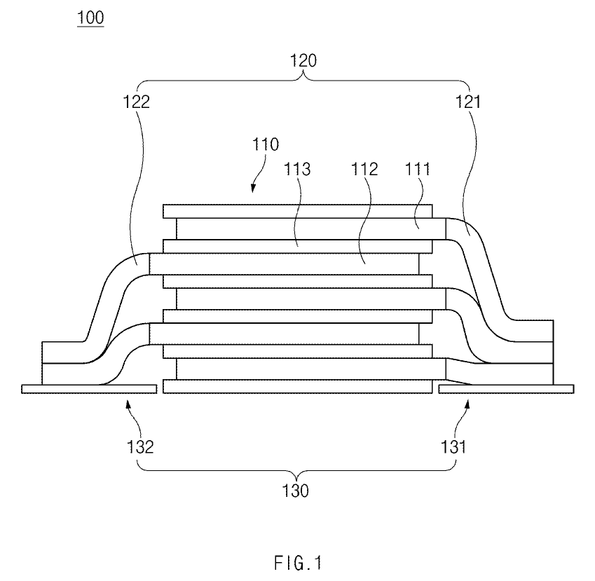

FIG. 1 is a view schematically illustrating the internal structure of a pouch-type secondary battery 100. The pouch-type secondary battery 100 includes an electrode assembly 110 formed by alternately stacking a positive electrode 111, a negative electrode 112, and a separator 113, and a pouch-type outer casing (not illustrated) that accommodates the electrode assembly 110 therein. Electrode tabs 120 are grouped into those having the same polarity to be welded together, and then, are additionally welded to metal leads 130, respectively. For example, positive electrode tabs 121 are welded to each other, and negative electrode tabs 122 are welded to each other. The welded positive electrode tabs 121 are further welded to a positive electrode lead 131, and the welded negative electrode tabs 122 are further welded to a negative electrode lead 132. Then, one end of each of the metal leads 130 protrudes outside the pouch to allow an electrical connection with an external device. Meanwhile, while the pouch-type secondary battery is described as an example in the present embodiment, the present disclosure may also be applied to other types of secondary batteries having a similar tab structure.

In manufacturing the positive electrode 111 and the negative electrode 112 of the secondary battery 100, a single-metal foil such as aluminum (Al) or a copper (Cu) is used as the current collector onto which an electrode slurry (e.g., a positive electrode slurry or a negative electrode slurry) is applied. However, in recent years, a composite current collector having a sandwich structure of a metal-a polymer-a metal has been used. The composite current collector is attracting significant attention as a next-generation material due to its advantages including improved electrode stability and weight reduction.

In order to manufacture a secondary battery cell using the composite current collector, a welding process is required to connect an electrode tab of the composite current collector and a metal lead. The conventional welding process includes an ultrasonic welding process that performs a welding using heat and friction, and a laser welding process that performs a welding by melting a metal using a laser as a heat source.

When a composite current collector tab and a metal lead are connected using the ultrasonic welding, friction significantly occurs at the portion where the metal lead and the composite current collector are in contact with each other, due to vibrations during the welding, which causes the problem that the metal lead damages the tab of the composite current collector. Further, when the composite current collector tab and the metal lead are connected using the laser welding, for example, there is a problem in that when low energy is applied, only the trace of laser irradiation remains, and the welding is not performed. Conversely, when the laser welding is performed by applying high energy, there is a problem in that only a hole is formed at a position irradiated with the laser, and the welding is not performed.

In consideration of the problems above, the present disclosure provides a method capable of joining the composite current collector tab to the metal lead using the laser welding while maintaining an appropriate joining strength and minimizing the damage to the composite current collector, and producing a secondary battery including the tab that maintains the appropriate joining strength.

Hereinafter, embodiments of the present disclosure will be described with reference to the accompanying drawings, to enable those skilled in the art to readily implement the invention.

Additionally, descriptions of a first embodiment may apply identically to subsequent embodiments to be described herein below unless conflict with each other.

### First Embodiment

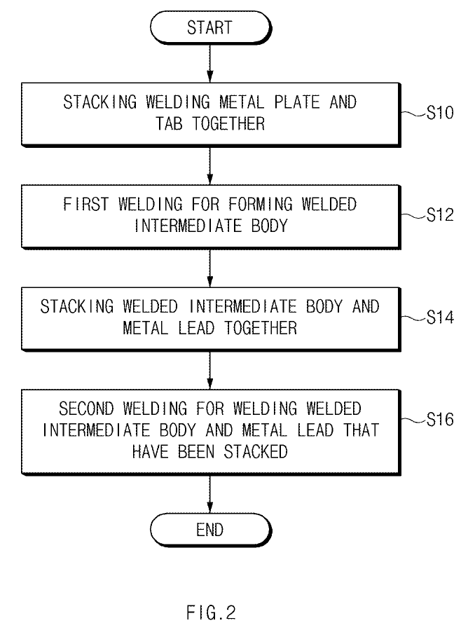

FIG. 2 is a flowchart illustrating an electrode lead joining method according to a first embodiment of the present disclosure.

Referring to FIG. 2, the electrode lead joining method according to the first embodiment of the present disclosure may include: a step of preparing a welding metal plate 40 and stacking the welding metal plate 40 and a tab 20 of a secondary battery together (S10); a first welding step of welding the stacked welding metal plate 40 and tab 20, thereby forming a welded intermediate body (S12); a step of stacking the welded intermediate body and a metal lead 30 together (S14); and a second welding step of welding the welded intermediate body and metal lead 30 (S16). In the descriptions of an embodiment of the present disclosure, the "electrode lead" may refer to a structure in which the tab 20, the metal lead 30, and the metal plate 40 are stacked together.

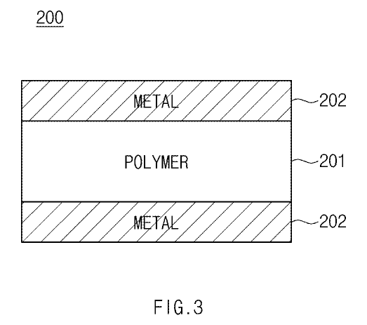

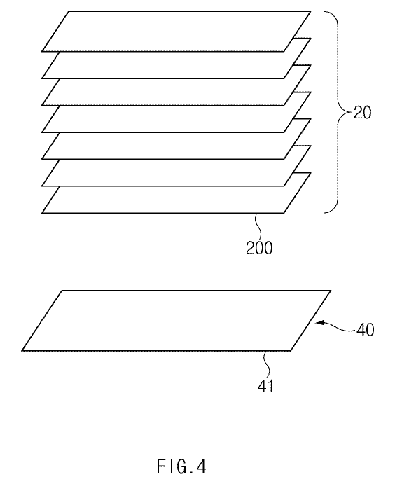

FIG. 3 is a sectional view illustrating the layered structure of a composite current collector 200 that makes up the tab 20 of the secondary battery according to the first embodiment of the present disclosure, and FIG. 4 is a view illustrating a step of stacking the tab 20 of the secondary battery and the welding metal plate 40 according to the first embodiment of the present disclosure.

Referring to FIGS. 3 and 4, the tab 20 of the secondary battery according to the first embodiment of the present disclosure may include a plurality of composite current collectors 200 each having a film shape. Each composite current collector 200 may include at least one metal layer 202 and at least one polymer layer 201. According to an embodiment, two metal layers 202 may be included in each composite current collector 200, and may be disposed on the lowermost side and the uppermost side of the at least one polymer layer 201, respectively. Unlike the conventional electrode foil made of a single material such as aluminum or a copper, the composite current collector 200 may be formed with a sandwich structure, in which the metal layers 202 are stacked on both sides of the polymer layer with the polymer layer interposed therebetween.

The polymer layer 201 included in the composite current collector 200 may be formed of at least one of, for example, polypropylene, polyimide, polyethylene naphthalate, polyethylene terephthalate, or combinations thereof. The metal layer 202 may be formed of any one of, for example, a copper, aluminum, or combinations thereof. According to an embodiment, the metal layer 202 may be coated thinly on the surface of the polymer layer 201 through, for example, a physical vapor deposition (PVD) process or an electroplating process.

Referring to FIG. 4, in the electrode lead joining method according to an embodiment of the present disclosure, the welding metal plate 40 is placed under the tab 20 of the secondary battery that is made up with the plurality of composite current collectors 200. The welding metal plate 40 may be formed of at least one of aluminum, a copper, an aluminum alloy, a copper alloy, or combinations thereof. For example, the welding metal plate 40 in the first embodiment may include a first welding metal plate 41 disposed under the tab 20. The first welding metal plate 41 and the tab 20 may be each formed in a plate shape, and according to an embodiment, the area of the first welding metal plate 41 may be larger than the area of the tab 20. A single composite current collector 200 may be used as the tab 20, or a plurality of composite current collectors 200 may be stacked and fixed to each other to form the tab 20. The first welding metal plate 41 and the tab 20 may each have a rectangular shape that is elongated in a specific direction when viewed along the vertical direction.

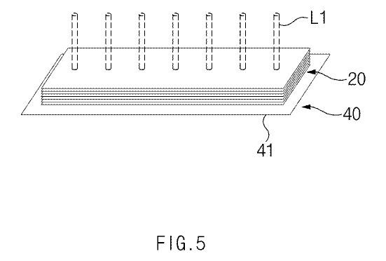

FIG. 5 is a view illustrating the first welding step of welding the stacked first welding metal plate 41 and tab 20, thereby forming a welded intermediate body (S12), after the step of preparing and stacking the welding metal plate 40 and the tab 20 (S10), in the electrode lead joining method according to the first embodiment of the present disclosure.

The electrode lead joining method according to the first embodiment of the present disclosure may include the step of stacking the first welding metal plate 41 and the tab 20 (S10). As illustrated in FIG. 4, the first welding metal plate 41 and the tab 20 may be stacked by placing the tab 20 on the first welding metal plate 41. The tab 20 is stacked downwardly from above the first welding metal plate 41, and thus, when viewed downward, the tab 20 may appear to fully overlap with the first welding metal plate 41 and be surrounded by the first welding metal plate 41.

The electrode lead joining method according to the first embodiment of the present disclosure may include the first welding step in which, after stacking the first welding metal plate 41 and the tab 20 (S10), the stacked first welding metal plate 41 and tab 20 are welded, thereby forming a welded intermediate body M1 (S12).

In the first welding step (S12), the first welding metal plate 41 and the tab 20 may be welded using a laser welding. In the first welding step (S12), a first laser beam L1, which is a laser beam irradiated onto the tab 20 and the first welding metal plate 41, may be irradiated along the vertical direction. In FIG. 5, the first laser beam L1 is irradiated downward. A plurality of first laser beams L1 may be irradiated. The plurality of first laser beams L1 may be arranged to be spaced apart from each other along the longitudinal direction of the tab 20 and the welding metal plate 40. The plurality of first laser beams L1 may be spaced apart from each other at equal intervals.

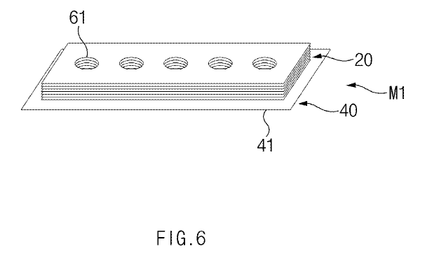

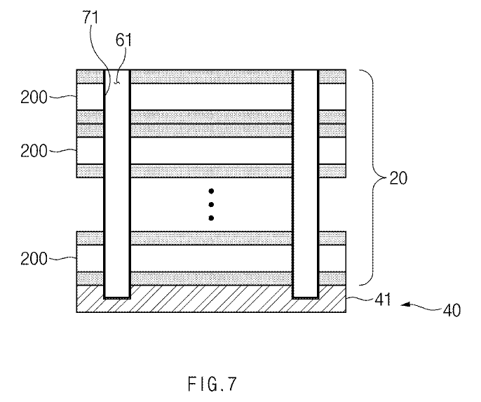

FIG. 6 is a view illustrating the welded intermediate body M1 that is formed by the electrode lead joining method according to the first embodiment of the present disclosure. FIG. 7 is a conceptual view illustrating the cross section of the welded intermediate body M1 according to the first embodiment of the present disclosure.

The welded intermediate body M1 is formed by joining the stacked tab 20 and first welding metal plate 41 together through the welding. A first welding hole 61 may be formed in the welded intermediate body M1 formed by the electrode lead joining method according to the first embodiment of the present disclosure. The first welding hole 61 is a hole formed in the welded intermediate body M1 by the welding operation performed on the tab 20 and the first welding metal plate 41 using, for example, the first laser beam L1. The first welding hole 61 may be formed by perforating or drilling the tab 20 of the welded intermediate body M1. The first welding hole 61 may be formed by drilling through the tab 20 and into a portion of the first welding metal plate 41 in contact with the tab 20, during the welding operation.

The portion surrounding the first welding hole 61 may be a coating layer 71 that is formed as the metal layers 202 of the tab 20 melt and subsequently solidify. Through the coating layer 71 made of the metal material, an electrical conduction may be implemented between the metal layers 202. Further, through the coating layer 71, an electrical conduction may be implemented between the metal layers 202 of the composite current collector 200 that makes up the tab 20, and the first welding metal plate 41.

According to an embodiment, the first welding hole 61 may be formed in a circular shape when viewed downward, which is the direction in which the tab 20 is stacked on the first welding metal plate 41. The first welding hole 61 is formed at a position where the first laser beam L1 is irradiated into the tab 20 and the first welding metal plate 41. Accordingly, a plurality of first welding holes 61 may be formed, and the centers of the plurality of first welding holes 61 may be spaced apart from each other at intervals equal to those between the plurality of first laser beams L1.

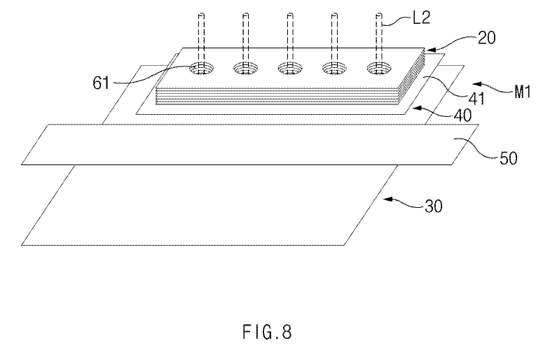

FIG. 8 is a view illustrating the step of stacking the welded intermediate body M1 and the metal lead 30 together (S14), and the second welding step of welding the stacked welded intermediate body M1 and metal lead 30 (S16), in the electrode lead joining method according to the first embodiment of the present disclosure.

The electrode lead joining method according to the first embodiment of the present disclosure may include the step of stacking the welded intermediate body M1 and the metal lead 30 together (S14). As illustrated, according to the first embodiment, the welded intermediate body M1 may be stacked on the metal lead 30 by being placed on the metal lead 30 downwardly from above. According to the first embodiment, the welded intermediate body M1 and the metal lead 30 may be stacked such that all of the portions corresponding to the first welding holes 61 overlap with the metal lead 30 along the vertical direction.

The electrode lead joining method according to the first embodiment of the present disclosure may include the second welding step of welding the stacked welded intermediate body M1 and metal lead 30 (S16). A lead film 50 may be attached to a portion of the metal lead 30, in order to seal an interior in relation to a packaging material such as a pouch at a later stage. The portion of the metal lead 30 that is coupled to the welded intermediate body M1 in the second welding step (S16) is the portion where the lead film 50 is not attached. For example, the lead film 50 may be attached to the center of the metal lead 30 in a specific direction, and the welded intermediate body M1 may be coupled to one side of the metal lead 30 in the specific direction. The other side of the metal lead 30 may be a portion that is exposed outside the battery case.

Similarly to the first welding step (S12), in the second welding step (S16), the welded intermediate body M1 and the metal lead 30 may be welded using the laser welding. A second laser beam L2, which is a laser beam irradiated into the tab 20 and the metal lead 30 in the second welding step, may be irradiated along the vertical direction. A plurality of second laser beams L2 may be irradiated. The plurality of second laser beams L2 may be arranged to be spaced apart from each other along the longitudinal direction of the welded intermediate body M1. The plurality of second laser beams L2 may be spaced apart from each other at equal intervals.

In the second welding step, the plurality of second laser beams L2 may be irradiated into the welded intermediate body M1 and the metal lead 30 such that the straight lines extending along the paths of the plurality of second laser beams L2 pass through the first welding holes 61.

In the second welding step (S16) of the first embodiment of the present disclosure, the plurality of second laser beams L2 may be irradiated downward from above the welded intermediate body M1 into the first welding holes 61. For example, the second laser beams L2 may be irradiated into the welded intermediate body M1 and the metal lead 30 through the first welding holes 61. As the second laser beams L2 are irradiated, the welded intermediate body M1 and the metal lead 30 are welded, and second welding holes 62 may be formed in the coupled body of the welded intermediate body M1 and the metal lead 30. The second welding holes 62 are holes formed in the coupled body of the welded intermediate body M1 and the metal lead 30 through the welding operation using, for example, the second laser beams L2. According to an embodiment, each second welding hole 62 may be formed in a circular shape when viewed downward, which is the direction in which the welded intermediate body M1 is stacked on the metal lead 30. When viewed downward, the center of the first welding hole 61 and the center of the second welding hole 62 may align to form a concentric circle. According to an embodiment, when viewed downward, the diameter of the second welding hole 62 may be smaller than or equal to the diameter of the first welding hole 61.

The output power of the second laser beams L2, which is the laser beams applied to the welded intermediate body M1 and the metal lead 30 in the second welding step (S16), is may be greater than or equal to the output power of the first laser beams L1, which are the laser beams applied to the tab 20 and the first welding metal plate 41 in the first welding step (S12). This is because the welding of the metal lead 30 and the welded intermediate body M1 requires energy greater than or equal to that required for the welding of the tab 20 and the first welding metal plate 41.

When the tab 20 is formed thick, and in this state, is welded to the metal lead 30 in the downward direction from the side of the tab 20, the welding may not be smoothly performed. In the first embodiment of the present disclosure, the second welding is performed through the first welding hole 61, so that the welded intermediate body M1 and the metal lead 30 may be welded to each other without performing a welding in the upward direction from the side of the metal lead 30. Further, by using the welding metal plate 40, the tab 20 including the plurality of composite current collectors 200 may be laser-welded to the metal lead 30 with the appropriate joining strength while minimizing the damage.

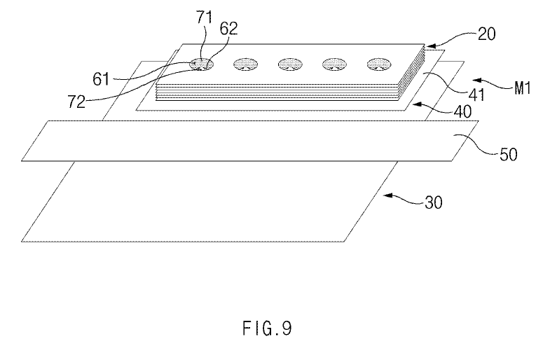

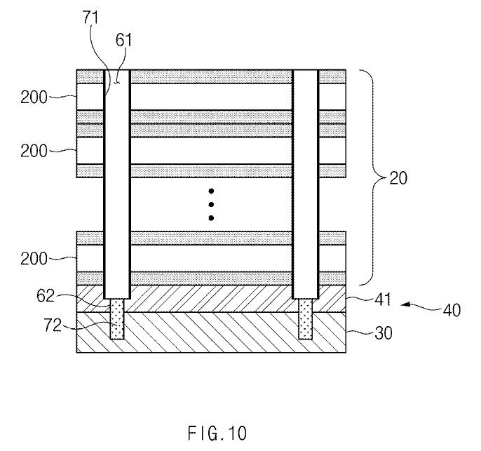

FIG. 9 is a view illustrating the state where the tab 20 and the metal lead 30 are joined to each other by the electrode lead joining method according to the first embodiment of the present disclosure. FIG. 10 is a conceptual view illustrating the cross section of the electrode lead according to the first embodiment of the present disclosure.

The welded intermediate body M1 is welded to the metal lead 30 in the second welding step (S16), so that the tab 20 and the metal lead 30 may be joined to each other as illustrated. The tab 20 and the first welding metal plate 41 of the welding metal plate 40 may be welded to the metal lead 30 in the second welding step (S16).

A welding bead 72 may be formed in the second welding step (S16) according to the first embodiment of the present disclosure. The welding bead 72 according to the first embodiment of the present disclosure is formed as the first welding metal plate 41 and the metal lead 30 melt by the welding, and subsequently, solidify. Accordingly, the welding bead 72 may be filled in the second welding hole 62. The welding bead 72 may be connected to the coating layer 71 formed on the tab 20 and the first welding metal plate 41.

As a result of the efficient laser welding, the trace of a backing board may remain on the rear surface of the welded material. In case of directly welding the tab 20 including the composite current collector 200 partially formed of the metal layer 202 and the metal lead 30 having a relatively large thickness, it is necessary to increase the laser output power to momentarily melt the thick metal lead 30 as well as the tab 20. When the welding is performed under the condition, the thin metal layer 202 of the composite current collector 200 spatters to a surrounding region due to the high laser output power, and thus, it may be difficult to directly weld the tab 20 and the metal lead 30. Meanwhile, when the welding metal plate 40 and the tab 20 are first laser-welded to each other, and then, the metal lead 30 is welded thereto, the welding in the first welding step (S12) may be performed by irradiating the laser at a relatively low output power, as compared to a case where the welding metal plate 40 is not used. Consequently, as the final product of the electrode lead joining method according to the first embodiment, the layered structure of the electrode lead is the tab 20-the first welding metal plate 41-the metal lead 30. Then, a secondary battery is finally obtained in the form that the welding metal plate 40 is added to the shape of the secondary battery 100 illustrated in FIG. 1, and may include an electrode assembly, the tab 20 extending from the electrode assembly, the first welding metal plate 41 coupled to the tab 20, and the metal lead 30 coupled to the first welding metal plate 41.

The electrode lead joining method according to the first embodiment of the present disclosure may be implemented by an electrode lead joining apparatus. The electrode lead joining apparatus may include: a workbench that may secure, for example, the metal lead 30 and the tab 20; a laser irradiation unit that may irradiate the laser beams L1 and L2 into, for example, the tab 20 secured on the workbench; a movement unit that positions each component at a desired location, such as moving the workbench and/or the laser irradiation unit; and a control unit that is electrically connected to the movement unit and the laser irradiation unit to transmit control commands. The workbench may include, for example, clamps for gripping and securing components such as the metal lead 30, the tab 20, and the welding metal plate 40. The movement unit may be a robot arm with a high degree of freedom, or may include a linear guide or a motor to perform rotational and linear movements. The laser irradiation unit may include, for example. a light source and an amplifier.

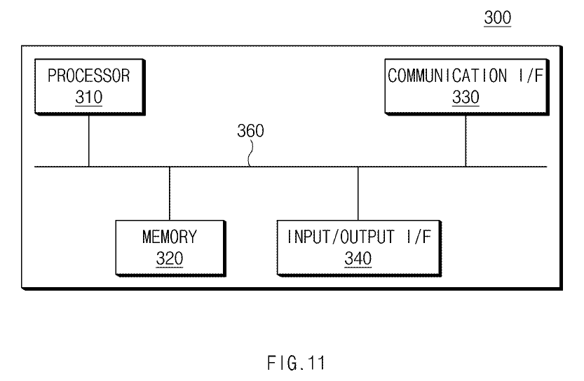

FIG. 11 is a block diagram illustrating the hardware configuration for implementing the control unit included in the electrode lead joining apparatus according to the present disclosure.

A control unit 300 according to an embodiment of the present disclosure may include a processor 310. The processor 310 is a component that includes elements capable of performing logical operations to execute control commands, and may include, for example, an integrated circuit (IC), an application specific integrated circuit (ASIC), a field programmable gate array (FPGA), and a central processing unit (CPU). The processor 310 may be connected to various components of the electrode lead joining apparatus according to the first embodiment of the present disclosure, to transmit signals in accordance with control commands to the components, and may also be connected to various sensors or acquisition units to receive acquired information in the form of signals. Since the processor 310 may be electrically connected to each of the components, it may include a communication module connected thereto by a wire or capable of conducting a wireless communication, thereby communicating with each of the components.

The control unit 300 may further include a memory 320. The control commands executed by the processor 310 may be stored in the memory 320 for use. The memory may be a device such as a hard disk drive (HDD), a solid state drive (SSD), a server, a volatile medium, or a nonvolatile medium, but its types are not limited thereto. The memory 320 may further store, for example, data necessary for the processor 310 to execute tasks. The control unit 300 may further include a communication I/F 330 and an input/output I/F 340. The control unit 300 may further include a bus 360 to electrically connect the components such as the processor 310 and the memory 320, and to allow the components to exchange electrical signals.

The electrode lead joining apparatus may receive necessary information through an input unit. The input unit may include means such as, for example, buttons, switches, or a tough screen to receive an input of the information, or may include a barcode, QR code, or RFID scanner to receive an input of the information in the manner of scanning codes. Through the input unit, information on the electrode assembly that is loaded into the electrode lead jointing apparatus may be received. The information input in the input unit is transmitted to the processor 310 through, for example, the communication I/F 330 and the input/output I/F 340 of the control unit 300.

### Second Embodiment

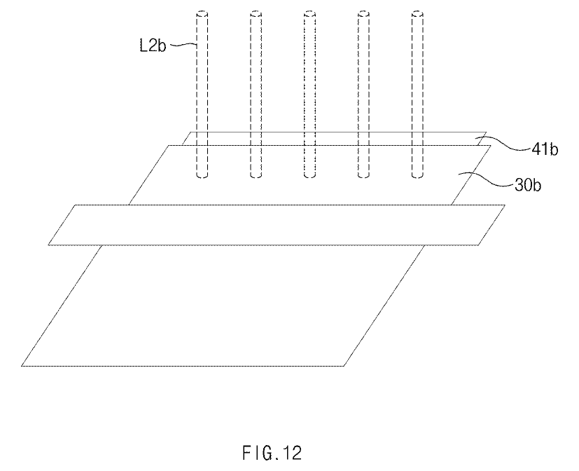

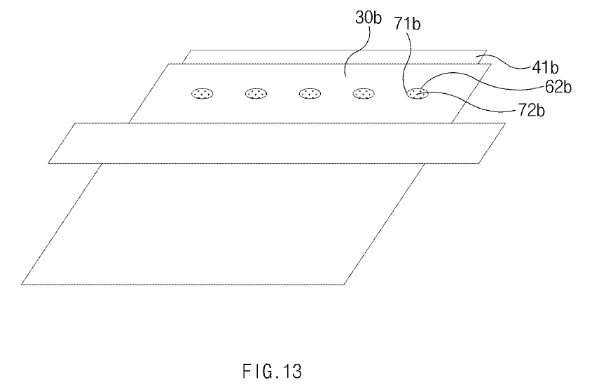

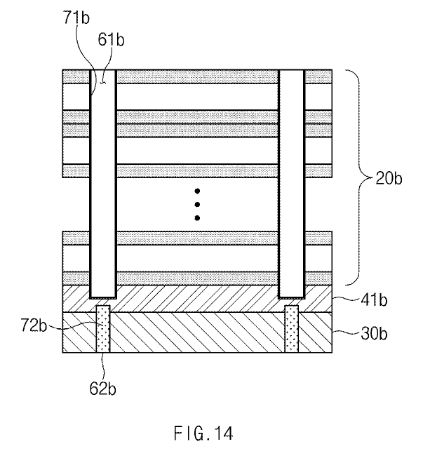

FIG. 12 is a view illustrating a second welding step of an electrode lead joining method according to a second embodiment of the present disclosure. FIG. 13 is a view illustrating an electrode lead according to the second embodiment of the present disclosure, in which the lower side thereof is exposed. FIG. 14 is a conceptual view illustrating the cross section of the electrode lead according to the second embodiment of the present disclosure.

The second embodiment of the present disclosure is substantially identical to the first embodiment of the present disclosure in the steps up to stacking the welded intermediate body, but different therefrom in the second welding step. Hereinafter, the second embodiment of the present disclosure will be described focusing on the differences from the first embodiment.

In the first embodiment of the present disclosure, the second laser beams L2 are irradiated downward from above the welded intermediate body M1. However, in the electrode lead joining method according to the second embodiment of the present disclosure, second laser beams L2b may be irradiated upward from below a metal lead 30b. By welding the metal lead 30b and a portion of a first welding metal plate 41b of the welded intermediate body from the side of the metal lead 30b, a tab 20b and the metal lead 30b may be coupled to each other while preventing the tab 20b formed of the composite current collector 200 from being damaged due to the additional welding in the second welding step.

By the second welding step according to the second embodiment of the present disclosure, second welding holes 62b may be formed in the lower surface of the metal lead 30b. A welding bead 72b may be filled in each of the second welding holes 62b. The welding bead 72b according to the second embodiment of the present disclosure may be formed as the metal lead 30b melts and subsequently solidifies. Unlike the first embodiment in which the first welding hole 61 and the second welding hole 62 are formed to be continuous and communicate with each other, in the second embodiment, the first welding hole 61b and the second welding hole 62b may not communicate with each other, and may be formed to be open upward and downward, respectively. Similarly, a coating layer 71b and the welding bead 72b may not be connected to each other.

### Third Embodiment

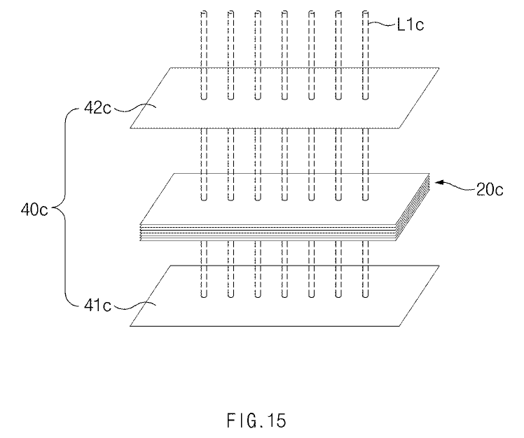

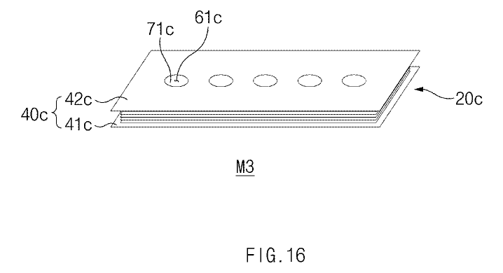

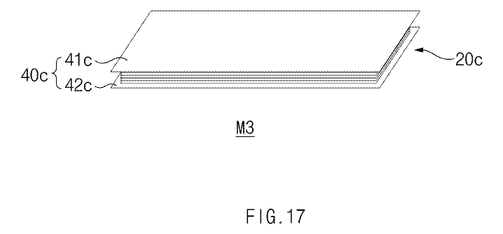

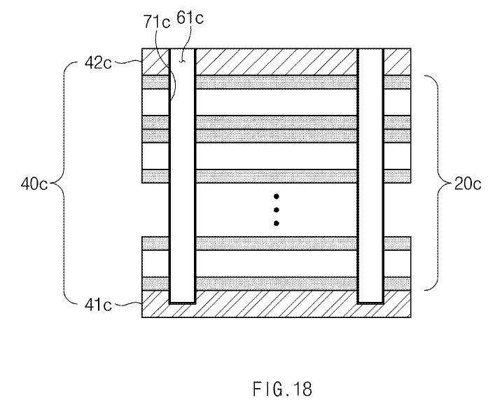

FIG. 15 is a view illustrating a first welding step of an electrode lead joining method according to a third embodiment of the present disclosure. FIG. 16 is a view illustrating a welded intermediate body M3 according to the third embodiment of the present disclosure, in which the upper side thereof is exposed. FIG. 17 is a view illustrating the welded intermediate body M3 according to the third embodiment of the present disclosure, in which the lower side thereof is exposed. FIG. 18 is a conceptual view illustrating the cross section of the welded intermediate body M3 according to the third embodiment of the present disclosure.

The third embodiment of the present disclosure is different from the first embodiment of the present disclosure in the number and arrangement of welding metal plates 40c. Hereinafter, the third embodiment of the present disclosure will be described focusing on the differences from the first embodiment.

Referring to FIG. 15, the welding metal plates 40c according to the third embodiment of the present disclosure may include a first welding metal plate 41c and a second welding metal plate 42c. Thus, a step of preparing the welding metal plates 40c according to the third embodiment of the present disclosure may include a step of preparing the first welding metal plate 41c and a step of preparing the second welding metal plate 42c. The first welding metal plate 41c may be disposed under a tab 20c, and the second welding metal plate 42c may be disposed on the tab 20c. Thus, the second welding metal plate 42c, the tab 20c, and the first welding metal plate 41c may be stacked in this order from top toward bottom.

The first welding step according to the third embodiment of the present disclosure may include a step of irradiating first laser beams L1c into the stacked welding metal plate 40c and tab 20c. Unlike the first embodiment in which the first laser beams encounter the tab 20 first, in the third embodiment, the first laser beams L1c encounter the second welding metal plate 42c first. Accordingly, the welded intermediate body M3 may be formed as illustrated in FIGS. 16-18.

As a result of the first welding step, the tab 20c and the first welding metal plate 41c may be drilled downward from the second welding metal plate 42c, so that first welding holes 61c may be formed. The portion surrounding each first welding hole 61c may be a coating layer 71c formed as the metal layer of the tab 20c and the second welding metal plate 42c melt and subsequently solidify. The thickness of the coating layer 71c in the third embodiment may be thicker than the thickness of the coating layer 71 in the first embodiment. Through the coating layer 71c formed of the metal material, an electrical conduction between the metal layers and an electrical conduction between the metal layers and the welding metal plate 40c may be implemented. Since the coating layer 71c is formed of a larger amount of metal due to the second welding metal plate 42c, the tab 20c and the welding metal plate 40c may be more firmly fixed to each other, and the electrical conductivity between the metal layers may be enhanced.

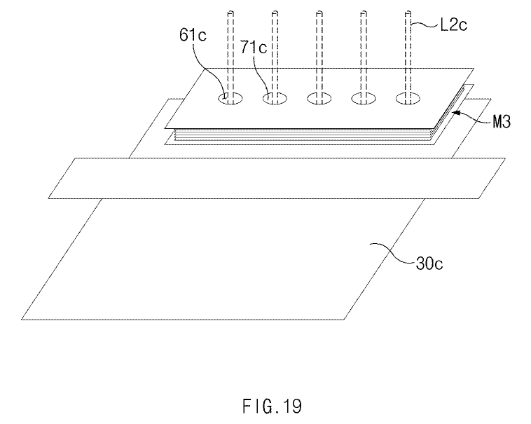

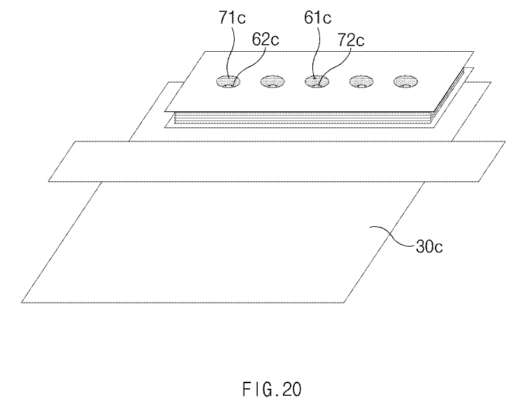

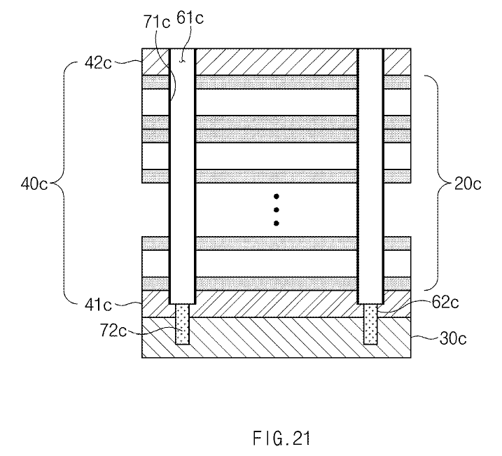

FIG. 19 is a view illustrating a second welding step of an electrode lead joining method according to the third embodiment of the present disclosure. FIG. 20 is a view illustrating an electrode lead according to the third embodiment of the present disclosure, in which the upper side thereof is exposed. FIG. 21 is a conceptual view illustrating the cross section of the electrode lead according to the third embodiment of the present disclosure.

The electrode lead joining method according to the third embodiment of the present disclosure may include a step of stacking the welded intermediate body M3 and a metal lead 30c together. As illustrated, according to the third embodiment, the welded intermediate body M3 may be stacked on the metal lead 30c by being placed on the metal lead 30c downwardly from above. According to the third embodiment, the welded intermediate body M3 and the metal lead 30 may be stacked such that all of the portions corresponding to the first welding holes 61c fully overlap with the metal lead 30 along the vertical direction.

The second welding step of welding the stacked welded intermediate body M3 and metal lead 30c according to the third embodiment of the present disclosure is different from the second welding step according to the first embodiment, in that the third embodiment further includes the second welding metal plate 42c. Second laser beams L2c may be irradiated to pass through the first welding holes 61c, and as a result, second welding holes 62c may be formed to be continuous from the first welding holes 61c. A welding bead 72c may be formed and filled in each second welding hole 62c.

### Fourth Embodiment

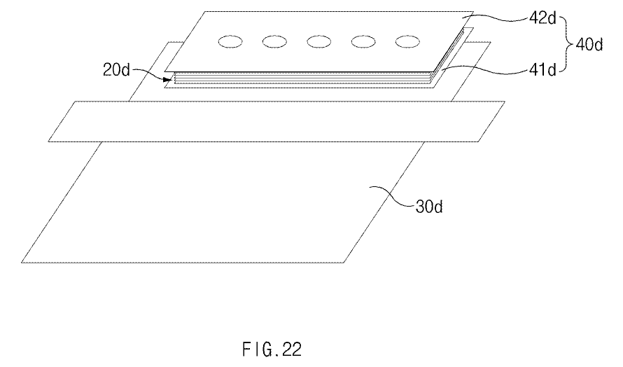

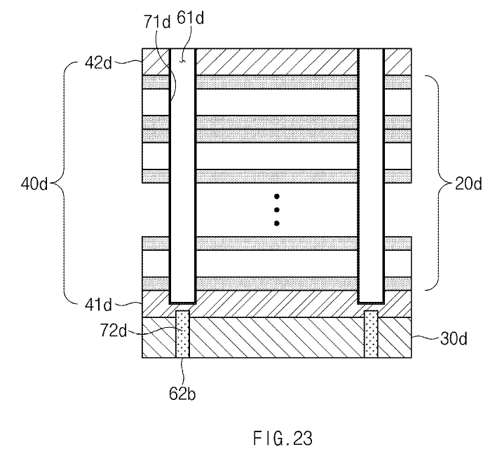

FIG. 22 is a view illustrating an electrode lead according to a fourth embodiment of the present disclosure, in which the upper side thereof is exposed. FIG. 23 is a conceptual view illustrating the cross section of the electrode lead according to the fourth embodiment of the present disclosure.

The fourth embodiment of the present disclosure is substantially identical to the third embodiment of the present disclosure in the steps up to stacking the welded intermediate body, but different therefrom in the second welding step. Hereinafter, the fourth embodiment of the present disclosure will be described focusing on the differences from the third embodiment.

In the second welding step according to the fourth embodiment of the present disclosure, the second laser beams may be irradiated upward from below a metal lead 30d as in the second embodiment. By welding the metal lead 30d and a portion of a first welding metal plate 41d of the welded intermediate body from the side of the metal lead 30d, a tab 20d and the metal lead 30d may be coupled to each other while preventing the tab 20d formed of the composite current collector 200 from being damaged due to the additional welding in the second welding step. Simultaneously, as in the third embodiment, the welding metal plate 40d includes the first welding metal plate 41d and a second welding metal plate 42d, so that a coating layer 71d having a sufficient thickness may be formed.

By the second welding step according to the fourth embodiment of the present disclosure, second welding holes 62d may be formed in the lower surface of the metal lead 30d. A welding bead 72d may be filled in each second welding hole 62d. In the fourth embodiment, the first welding hole 61d and the second welding hole 62d may not communicate with each other, and may be formed to be open upward and downward, respectively.

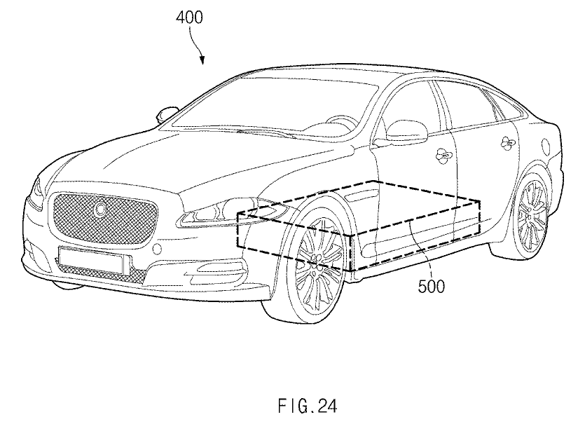

Referring to FIG. 24, a vehicle 400 according to an embodiment of the present disclosure may include one or more battery packs 500 that include the secondary battery manufactured by the methods according to the embodiments described above. The vehicle 400 according to the present disclosure may be, for example, an electric vehicle, a hybrid vehicle, or a plug-in hybrid vehicle. The vehicle 400 includes various types of vehicles such as four-wheeled vehicles, two-wheeled vehicles, and three-wheeled vehicles. The vehicle 400 may operate by receiving power from the battery pack 500 according to an embodiment of the present disclosure.

The foregoing description is merely illustrative of the technical idea of the present disclosure, and various modifications and changes may be made by those skilled in the art of the present disclosure within the scope that does not depart from the essential features of the present disclosure.

What is claimed is:

1. An electrode lead joining method comprising:
stacking a welding metal plate and a tab of a secondary battery;
welding the welding metal plate and the tab that have been stacked, thereby forming a welded intermediate body;
stacking the welded intermediate body and a metal lead;
welding the welded intermediate body and the metal lead that have been stacked.

2. The electrode lead joining method according to claim 1, wherein at the welding the welded intermediate body and the metal lead, a second welding hole is formed in the welded intermediate body through the welding.

3. The electrode lead joining method according to claim 2, wherein a diameter of the second welding hole is smaller than or equal to a diameter of a first welding hole, which is a hole formed in the welded intermediate body at the welding the welding metal plate and the tab.

4. The electrode lead joining method according to claim 3, wherein when viewed along a direction in which the welded intermediate body and the metal lead are stacked, the first welding hole and the second welding hole have coincident centers.

5. The electrode lead joining method according to claim 1, wherein at the welding the welded intermediate body and the metal lead, the welded intermediate body and the metal lead are welded through the first welding hole that is the hole formed in the welded intermediate body at the welding the welding metal plate and the tab.

6. The electrode lead joining method according to claim 1, wherein at the welding the welded intermediate body and the metal lead, the welded intermediate body and the metal lead are welded from a side of the metal lead.

7. The electrode lead joining method according to claim 1, wherein at the stacking the welding metal plate and the tab, a plurality of welding metal plates is stacked to be disposed on an upper side and a lower side of the tab, respectively.

8. The electrode lead joining method according to claim 1, wherein the tab includes a composite current collector includes at least one metal layer and at least one polymer layer.

9. The electrode lead joining method according to claim 8, wherein as the at least one metal layer, two metal layers are provided and disposed on a lowermost side and an uppermost side of the at least one polymer layer.

10. The electrode lead joining method according to claim 8, wherein the at least one polymer layer is formed of at least one of polypropylene, polyimide, polyethylene naphthalate, polyethylene terephthalate, or combinations thereof.

11. The electrode lead joining method according to claim 1, wherein at the forming the welded intermediate body, the welding metal plate and the tab are laser-welded.

12. The electrode lead joining method according to claim 11, wherein an output power of a laser beam applied at the welding the welded intermediate body and the metal lead is greater than or equal to an output power of a laser beam applied at the welding the welding metal plate and the tab.

13. A secondary battery comprising:
an electrode assembly;
a tab extending from the electrode assembly;
a first welding metal plate coupled to the tab; and
a metal lead coupled to the first welding metal plate.

14. The secondary battery according to claim 13, further comprising:
a second welding metal plate coupled to one of surfaces of the tab that is opposite to a remaining surface of the tab to which the first welding metal plate is coupled.

15. The secondary battery according to claim 13, wherein the tab includes a composite current collector formed with at least one metal layer and at least one polymer layer.

16. A vehicle comprising the secondary battery of claim 15.
